(19) United States
(12) Patent Application Publication
(10) Pub. No.: US 2006/0198436 A1
(43) Pub. Date: Sep. 7, 2006

(54) Bandwidth reduction by one half

(76) Inventor: Sam Cowan, Stromsburg, NE (US)

Correspondence Address: SAM COWAN, 309 EAST 10TH STR BX 266, STROMSBURG, NE, 68666, US

(21) Appl. No.: 11/341,055

(22) Filed: Jan. 30, 2006

Related U.S. Application Data
(60) Provisional application No. 60/655,257, filed on Feb. 23, 2005.

(51) Int. Cl. H04B 1/66

(52) U.S. Cl. 375/240

(57) ABSTRACT

A method for transmitting information on electromagnetic waves that requires less bandwidth than other common modes. The information is divided into two parts in the manner of the Weaver method of single sideband generation. These two parts each have one-half the bandwidth of the original information. The two parts are modulated on separate transmitters operating on the same frequency. The signals are kept separate through the use of circular polarized antennas. The received signals are demodulated and then recombined in a circuit identical to the one that divided them in the transmitter. The recombined signal is the same as the original information. The bandwidth used in the electromagnetic spectrum is one-half that of the information.

### CROSS-REFERENCE TO RELATED APPLICATIONS

This application claims the benefit of provisional patent application Ser. No. US60/655257 filed Feb. 23, 2005 by the present inventor.

### FEDERALLY SPONSORED RESEARCH

Not applicable

### SEQUENCE LISTING OR PROGRAM

Not applicable

### BACKGROUND OF THE INVENTION—FIELD OF INVENTION

This invention generally relates to communication using electromagnetic waves, specifically to the reduction of the bandwidth required to accomplish this communication.

### BACKGROUND OF INVENTION—PRIOR ART

Communication via means of electromagnetic waves consists of four basic functions.
a. A carrier oscillator
b. The intelligence to be communicated.
c. The modulator in which the intelligence varies the carrier in either amplitude or angle or some subset thereof.
d. The antenna system which radiates the wave. This antenna system is polarized depending upon its physical position relative to the earth's horizon.

The radiated wave occupies a certain width in the electromagnetic spectrum depending upon the type of modulation and the frequencies inherent in the intelligence information.

| Examples: | type | bandwidth | |
|---|---|---|---|
| | AM broadcast | 10 | khz |
| | FM broadcast | 200 | khz |
| | Television | 6 | mhz |
| | SSB voice | 2.7 | khz |

Reducing the bandwidth is important in that it allows for more station assignments in a given spectrum, and it can increase the signal to noise ratio by reducing the amount of noise received.

### BACKGROUND OF INVENTION—OBJECTS AND ADVANTAGES

Objects and advantages of the present invention are:
a. Reduce the bandwidth required to transmit intelligence via electromagnetic waves by a factor of one half.
b. The bandwidth reduction allows for twice as many station assignments in any given spectrum allotment.
c. The bandwidth reduction also allows for weaker signals to be received by reducing the white noise received.

### SUMMARY

This invention consists of well known electronic circuits. They are put together in a unique manner such that information can be transmitted and received utilizing one half the spectrum bandwidth that would otherwise be required.

### DRAWING—FIGURES

FIG. 1 is a block diagram of the transmitter half of the invention.

FIG. 2 is a block diagram of the receiver half of the invention.

### DRAWING—REFERENCE NUMERALS

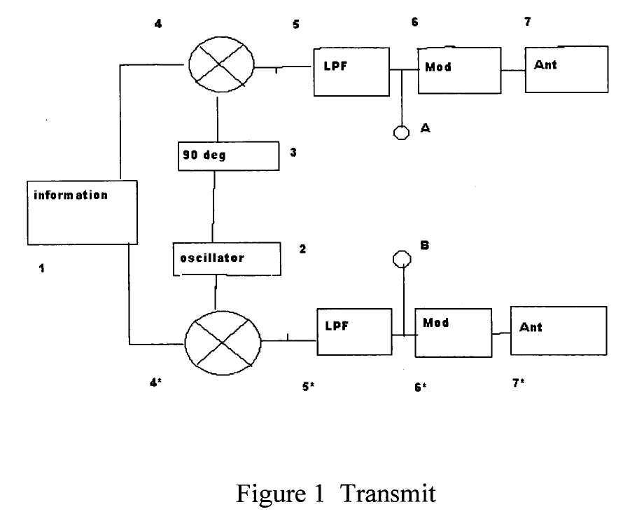

FIG. 1 Transmitter

The information is divided into two components ninety degrees out of phase and one half the bandwidth of the original information. The two components are modulated and transmitted on the same frequency through circular polarized antennas. One antenna is left hand circular polarized and one is right hand circular polarized.

1. The information to be transmitted. This information is contained within a spectrum of F₁ to F₂.

2. Oscillator—the frequency of this oscillator is half way between F₁ and F₂.

3. Shifts the phase of the oscillator by 90°.

4. & 4* double balanced modulators—the output of these modulators consist of the mixing frequencies (oscillator+information) and (oscillator—information). The outputs are also 90° out of phase with each other.

5. & 5* low pass filters—with a cut-off frequency equal to the oscillator frequency, these filters eliminate the (oscillator+information) frequencies.
What is left at points (A) and (B) are the difference frequencies (oscillator—information). The signals at (A) and (B) have one half the bandwidth of the original information.
The signals at (A) and (B) are 90° out of phase. For information frequencies below the oscillator frequency if (A) leads (B) by 90° then for information frequencies above the oscillator frequency (B) leads (A) by 90°.
For information frequencies above the oscillator frequency if (A) lags (B) by 90° then for information frequencies above the oscillator frequency (B) lags (A) by 90°.

6 & 6* Modulator—all common modes of modulation can be used including but not limited to:
A.M., F.M., P.M., SSB

7. & 7* Antennas—the antennas are circular polarized, one left hand and one right hand.

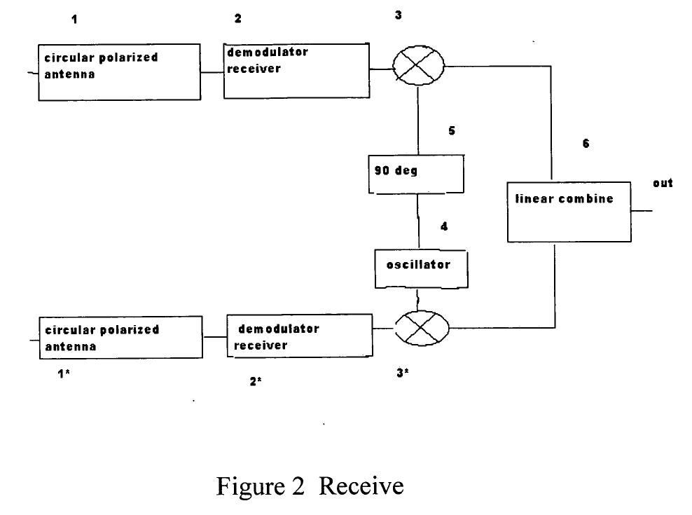

FIG. 2 Receiver

Circular polarized antennas, one left hand and one right hand receive the two signals. This allows for separation of two signals on the same frequency. The two signals are fed to two receivers/demodulators that reproduce the two signals formed at points (A) and (B) in the transmitter. These two are mixed with the same oscillator frequency used in the transmitter. The combination of these two mixing products yields the original information.

1. & 1* Antennas—the antennas are circular polarized, one left hand and one right hand. This allows separation of two signals transmitted on the same frequency.

2. & 2* The receiver/demodulators recover the information as it existed at points (A) and (B) in the transmit circuit.

3. & 3* Double balanced modulators—Mixes the information at points (A) and (B) with an oscillator.

4. Oscillator—same frequency as the transmit oscillator.

5. Shifts the phase of the oscillator by 90°.

6. 6. Linear combine—combines the two signals to reproduce the original information from the transmitter.

What I claim as my invention is:

1. A method for reducing the spectrum bandwidth needed to convey intelligence when using electromagnetic waves. The reduction is one half the original spectrum bandwidth. The method consist of:
A. Circular polarized antennas to separate signals.
B. A circuit for mixing the intelligence to provide two paths that are 90 degrees apart and each having one half bandwidth.
